(19) United States
(12) Patent Application Publication
(10) Pub. No.: US 2020/0120941 A1
(43) Pub. Date: Apr. 23, 2020

(54) ANTI-BLOOMING COMPOSITION

(71) Applicant: AAK AB, Malmo (SE)

(72) Inventor: Jeroen DEMEURISSE, Malmo (SE)

(21) Appl. No.: 16/615,880

(22) PCT Filed: May 29, 2018
(86) PCT No.: PCT/SE2018/050539

§ 371 Date: Nov. 22, 2019

(30) Foreign Application Priority Data
May 30, 2017 (SE) 1730147-4

(51) Int. Cl. A21D 2/16; A21D 2/18; A21D 13/24; A21D 13/28; A21D 13/80; A23G 1/36

(52) U.S. Cl. CPC A21D 2/165; A21D 2/181; A23G 1/36; A21D 13/28; A21D 13/80; A21D 13/24

(57) ABSTRACT

The present invention relates to a dough for forming an edible product having substantially no bloom formation on the surface or wherein the bloom formation is reduced, retarded, or delayed, wherein the dough comprises a vegetable fat composition having anti-blooming properties in the formed edible food product. The present invention also relates to methods of preparing such a dough, and edible food products formed therefrom. Further, the present invention encompasses uses of such vegetable fat compositions for preventing, reducing, retarding, or delaying bloom formation in edible food products, and particularly those having chocolate coatings. Still further, the present invention relates to a vegetable fat composition, which when formed into an edible food product, possesses anti-blooming properties.

### TECHNICAL FIELD

The present invention relates to a dough for forming an edible product having substantially no bloom formation on the surface or wherein the bloom formation is reduced, retarded or delayed, wherein the dough comprises a vegetable fat composition having anti-blooming properties in the formed edible food product. The present invention also relates to methods of preparing such a dough, and edible food products formed therefrom. Further, the present invention encompasses uses of such vegetable fat compositions for preventing, reducing, retarding or delaying bloom formation in edible food products, and particularly those having chocolate coatings. Still further, the present invention relates to a vegetable fat composition, which when formed into an edible food product, possesses anti-blooming properties.

### BACKGROUND OF THE INVENTION

Confectionery food products, such as cookies and chocolate, are known to have long shelf-lives due to high sugar content, and thus do not suffer microbiological degradation in the same way as other types of foods. However, the shelf-life of a food product is not solely determined by its microbiological degradation, and changes in appearance, texture and/or flavour of the product can also limit perceived shelf-life.

With respect to confectionary food products comprising fats, such as cookies or chocolate, one significant issue is the shortening of the perceived shelf-life due to a phenomenon referred to as “fat blooming”.

There are two main types of fat blooming which can affect confectionary food products. The first relates to the crystal form of the fats which are present in a surface coating of a confectionary food product, such as a chocolate coating. In its simplest form, such a chocolate coating must be tempered. The tempering process serves the purpose of making a sufficient amount of desired type of seed crystals of the solid fats present in the chocolate, which in turn is responsible for obtaining a rather stable chocolate product which is less prone to changes in the crystal composition of the solid fats. The desired seed crystals are of the crystal form Form V. However, the solid fat crystals can transform from a Form V to a Form VI crystal phase. Such re-crystallisation of Form VI crystals may then result in bloom on the surface of the chocolate confectionary. This first type of bloom in chocolate coatings is a well-studied phenomenon. In the prior art, various ways of avoiding this bloom effect are described. Such suggestions for avoiding bloom formation relate to optimising tempering conditions or adding anti-bloom agents to the chocolate such as high-melting milk fat fractions, certain emulsifiers (as for example sorbitan tristearate) or specific triglyceride compositions.

Emulsifiers such as sorbitan monostearate (SMS), sorbitan tristearate (STS), and combinations thereof have been shown to be useful in reducing or preventing fat bloom (see “Food and Beverage Stability and Shelf Life” edited by David Kilcast and Persis Subramaniam, page 725 and “Fat bloom in chocolate and compound coatings”, Eur. J. Lipid Sci. Technol. 106 (2004) 241-274). However, the use of sorbitan tristearate (STS) within food products is limited to chocolate and compound coatings in the US (see “Food Emulsifiers and Their Applications” edited by Gerard L. Hasenhuettl, Richard W. Hartel, page 247), and therefore cannot be used generally for confectionery food products. Furthermore, other types of emulsifier, such as sorbitan monosterate (SMS), are approximately half as effective as sorbitan tristearate (STS), and thus would require double the amount compared to sorbitan tristearate (STS), which affects the taste and/or texture of the resulting confectionary food product.

U.S. Pat. No. 5,424,090 discloses an anti-bloom agent comprising not less than 40% by weight of triglycerides of the form SatSatU, wherein Sat is a saturated fatty acid and wherein U is an unsaturated fatty acid, and wherein not less than 75% of all the saturated fatty acids are selected from the group comprising stearic acid and palmitic acid. The anti-bloom agent is intended for being added to a hard butter or a hard butter product, such as raw fats and oils, e.g. a cocoa butter product, such as chocolate in an amount that increases the content of SatSatU triglycerides in that product by 2-25%. Addition of the anti-bloom agent according to U.S. Pat. No. 5,424,090 results in delayed formation of Form VI crystals.

Fat blooming can also be caused by the migration of fat to a surface of a confectionary food product, and subsequent re-crystallisation of the fat at the surface. Typically, fats rich in symmetrical SatUSat triglycerides are prone to this type of bloom. In such a process, it is believed that the fat migrates through pores and cracks in the confectionary food product, potentially dissolving other fats, to the surface of the product—even where such a product comprises a coating.

This re-crystallisation of the fat causes the presence of lighter coloured spots (also referred to as “whitening”) at the surface of the product, a loss of shine, altered product texture and/or softening. Anti-bloom agents which stop the Form V to Form VI transformation, such as described above, do not address this type of bloom and it is this type of fat blooming which the present invention aims to address. Thus, there is a need in the art for alternative methods of providing an anti-blooming agent in order to prevent, reduce, retard or delay fat blooming caused by the migration of fat to a surface of a confectionary food product, and particularly those that are suitable for use with edible food products in general. It would of course be particularly preferable for such alternatives to avoid one or more of the issues associated with known anti-blooming agents. Of particular interest, it would be beneficial to provide a dough having anti-blooming characteristics when formed into an edible food product, and more particularly confectionary products, such as cookies and chocolate coated cookies. Such anti-blooming properties should preferably allow for an extended period of stability in order to increase the perceived shelf-life of such products.

### SUMMARY OF THE INVENTION

In accordance with an aspect of the present invention, there is provided a dough for forming an edible product having substantially no bloom formation on the surface or wherein the bloom formation is reduced, retarded or delayed on the surface of the product, wherein the dough comprises:
a. 5 to 40 wt % of a vegetable fat composition for preventing, reducing, retarding or delaying bloom formation on the surface of the baked edible product;
b. 5 to 50 wt % of sugar; and
c. 5 to 75 wt % of flour
   wherein the vegetable fat composition comprises:
i. a (PSU+SPU+PPU+SSU+SUU+USU)/(PUP) ratio of greater than 1.0;
ii. PPP+PPS+PSP+SSP+SPS+SSS in an amount of less than 15 wt. %;
iii. SSU+PPU+PSU+SPU in an amount of greater than 6 wt. %;
iv. UUU in an amount of greater than 6 wt. %; and
v. C₁₂+C₁₄ saturated fatty acids in an amount of less than 2.5 wt. % in which U is the sum of C18:1, C18:2 and C18:3 unsaturated fatty acids, S is stearic acid (C18:0), P is palmitic acid (C16:0); and wherein the fat composition has:
1. a solid fat content at 10° C. greater than 10%;
2. a solid fat content at 20° C. less than 50% ; and
3. a solid fat content at 20° C.—solid fat content at 35° C. less than 30%.

The inventors have surprisingly found that an edible food product formed from a dough in accordance with the present invention may provide extended resistance to fat blooming by preventing, reducing, retarding or delaying fat bloom formation. For example, the edible food products formed are stable and do not display the presence of fat blooming for at least 10 weeks, for example at least 18 weeks, and as much at least 50 weeks, or even more.

The vegetable fat composition used in the dough of the present invention may be in the form of a solid or liquid at room temperature, or a mixture thereof. In some embodiments, the vegetable fat composition may be formed from a mixture or blend of two or more vegetable fats. Preferably, the vegetable fat composition may be selected from one or more of sunflower oil, high oleic sunflower oil, soybean oil, rapeseed oil, corn oil, safflower oil, sesame oil, rice oil, olive oil, peanut oil, flaxseed oil, cottonseed oil, shea butter, cocoa butter, illipe, sal, and palm oil, palm kernel oil, coconut oil, all with fractions thereof, such as olein and/or stearin fractions, as well as interesterified and/or hydrogenated fats or oils thereof.

Preferably, the vegetable fat composition is selected from a non-hydrogenated fat.

In a preferred embodiment, the vegetable fat composition may be selected from one or more of the non-hydrogenated forms of palm oil, sheabutter, rapeseed oil, sunflower oil, and high oleic sunflower oil.

In some embodiments, the vegetable fat composition is selected from a non-hydrogenated fat comprising more than 15 wt % palm oil or its fractions; more than 15 wt % shea or its fractions; and/or more than 25 wt % interesterified components.

Preferably, the vegetable fat composition comprises:
more than 15 wt % palm oil or its fractions;
more than 15 wt % shea or its fractions; and
more than 25 wt % interesterified components.

In a preferred embodiment, the vegetable fat composition comprises a (PSU+SPU+PPU+SSU+SUU+USU)/(PUP) ratio of greater than 1.5, for example greater than 5.0, such as greater than 10.0.

Preferably, the vegetable fat composition comprises a (PSU+SPU+PPU+SSU+SUU+USU)/(PUP) ratio of less than 50, for example less than 25, such as less than 15.

In a preferred embodiment, the vegetable fat composition comprises PPP+PPS+PSP+SSP+SPS+SSS in an amount of less than 10 wt. %, for example less than 7 wt %, such as less than 5 wt %.

Preferably, the vegetable fat composition comprises PPP+PPS+PSP+SSP+SPS+SSS in an amount greater than 0.2 wt %, for example greater than 1 wt %, such as 3 wt %.

In a preferred embodiment, the vegetable fat composition comprises PSU+SPU+SSU+PPU in an amount of greater 9 wt %, for example greater than 12 wt %, such as 15 wt %.

Preferably, the vegetable fat composition comprises PSU+SPU+SSU+PPU in an amount less than 30 wt %, for example less than 25 wt %, such as 17 wt %.

In a preferred embodiment, the vegetable fat composition comprises UUU in an amount of greater than 10 wt %, for example greater than 15 wt %, such as greater than 25 wt %.

In a preferred embodiment, the vegetable fat composition comprises UUU in an amount of less than 50 wt %, for example less than 40 wt %, such as less than 30 wt %.

In a preferred embodiment, the vegetable fat composition comprises SUS+PUP in an amount of less than 15 wt %, for example, less than 12 wt %, such as less than 10 wt %.

In a preferred embodiment, the vegetable fat composition comprises SUS+PUP in an amount greater than 5 wt %, for example greater than 6 wt %, such as greater than 8 wt %.

In a preferred embodiment, the vegetable fat composition comprises SAFAs in an amount greater than 20 wt %, for example greater than 25 wt %, such as greater than 35 wt %.

In a preferred embodiment, the vegetable fat composition comprises SAFAs in an amount of less than 55 wt %, for example 50 wt %, such as less than 40 wt %.

In a preferred embodiment, the vegetable fat composition comprises a C_{18:0}/C_{16.0} ratio greater than 0.3, for example greater than 0.5, such as greater than 0.7.

In a preferred embodiment, the vegetable fat composition comprises a C_{18:0}/C_{16:0} ratio of less than 4, for example less than 3, such as less than 2.5.

In a preferred embodiment, the vegetable fat composition comprises PSU+SPU in an amount greater than 5 wt %, for example greater than 6 wt %, such as greater than 8 wt %.

In a preferred embodiment, the vegetable fat composition comprises PSU+SPU in an amount of less than 15 wt %, such as less than 12 wt %, for example less than 10 wt %.

In a preferred embodiment, the vegetable fat composition has a solid fat content at 10° C. of greater than 20%, for example greater than 25%, such as greater than 30%.

In a preferred embodiment, the vegetable fat composition has a solid fat content at 10° C. of less than 50%, for example less than 45%, for example less than 40%.

In a preferred embodiment, the vegetable fat composition has a solid fat content at 20 ° C. of greater than 10%, for example greater than 15%, such as greater than 20%.

In a preferred embodiment, the vegetable fat composition has a solid fat content at 20 ° C. of less than 35%, for example less than 30%, such as less than 25%.

In a preferred embodiment, the vegetable fat composition has a solid fat content at 35 ° C. of between 0% and 10%, for example between 2% and 8%, such as between 4% and 6%.

The solid fat content can be measured using Nuclear Magnetic Resonance (NMR) spectroscopy, as described in the IUPAC Standard Method IUPAC 2.150a or AOCS Official Method Cd 16b-93.

In a preferred embodiment, the vegetable fat composition comprises C₁₂+C₁₄ saturated fatty acids in an amount of at least 0.01 wt %, for example at least 0.2 wt %, such as at least 0.5 wt %.

In a preferred embodiment, the vegetable fat composition comprises C₁₂+C₁₄ saturated fatty acids in an amount of less than 1.4 wt %, for example less than 1.2 wt %, such as less than 1.0 wt %.

In a preferred embodiment, the vegetable fat composition comprises trans unsaturated fatty acids in an amount of less than 5 wt %, for example less than 2 wt %, such as less than 1 wt %.

In accordance with the present invention the term “dough”, is considered to encompass both soft and stiff dough, which types of dough are well known in this field.

In a preferred embodiment of the present invention, the dough composition may comprise sugar in an amount of between 10 wt % and 40 wt % sugar, for example between 15 wt % and 35 wt %.

In accordance with the present invention, the term “sugar” is considered to encompass both sugars and sugar substitutes, such as artificial sweeteners.

In some embodiments, the dough composition may comprise a mixture of both sugar and sugar substitutes. By way of example, the sugar substitutes may form up to 25 wt %, or up to 50 wt %, or in some embodiments up to 75 wt % of the total sugar content. The sugar substitute may be selected from acesulfame potassium, agave nectar, aspartame, neotame, stevia leaf extract, saccharin, sucralose, and inulin or a combination thereof. Preferably, the sugar substitute is inulin.

The dough composition may further comprise flour in amount of between 10 wt % to 70 wt %, such as 20 wt % to 65 wt %. Preferably, the flour is selected from cereal flour, wheat flour (strong flour, medium flour, soft flour, and the like), barley flour, rice flour, corn flour, rye flour, buckwheat flour, soy flour, and the like.

In some embodiments, the dough composition may further comprise one or more of milk powder (where present generally in amount of up to 10 wt %), protein (where present generally in amount of up to 5 wt %), starch (where present generally in amount of up to 20 wt %), salt (where present generally in amount of up to 5 wt %), spices (where present generally in amount of up to 5 wt %), flavour components (where present generally in amount of up to 5 wt %), colourants (where present generally in amount of up to 5 wt %), cocoa (where present generally in amount of up to 5 wt %), thickening and gelling agents (where present generally in amount of up to 5 wt %), egg powder (where present generally in amount of up to 10 wt %), enzymes (where present generally in amount of up to 2 wt %), gluten (where present generally in amount of up to 5 wt %), preservatives (where present generally in amount of up to 2 wt %), oxidising agents (where present generally in amount of up to 2 wt %), reducing agents (where present generally in amount of up to 2 wt %), anti-oxidants (where present generally in amount of up to 2 wt %) and acidity regulators (where present generally in amount of up to 2 wt %). Such components are in general added in dry form, and may be known collectively as ‘dry components’.

In some embodiments, the dough composition may comprise one or more of eggs (where present generally in an amount of up to 40 wt %), water (generally in an amount of up to 50 wt %, such as between 1 and 50 wt %, preferably between 5 and 20 wt %), liquid sugar and syrups (where present generally in an amount of up to 25 wt %), milk (where present generally in amount of up to 40 wt %), liquid flavours (where present generally in amount of up to 5 wt %), alcohols (where present generally in amount of up to 5 wt %), humectants (where present generally in amount of up to 5 wt %), honey (where present generally in amount of up to 10 wt %), liquid preservatives (where present generally in amount of up to 2 wt %), liquid oxidising agents (where present generally in amount of up to 2 wt %), liquid reducing agents (where present generally in amount of up to 2 wt %), liquid anti-oxidants (where present generally in amount of up to 2 wt %), liquid acidity regulators (where present generally in amount of up to 25 wt %) and liquid enzymes (where present generally in amount of up to 2 wt %). Such components are in general added in wet form, and may be known collectively as ‘wet components’.

In accordance with the present invention, although the addition of a further anti-blooming agent is not required in order to prevent, reduce, retard or delay fat bloom, in some embodiments the dough may further comprise an anti-blooming agent in an amount of less than 5 wt %, for example less than 2 wt %, such as less than 1 wt % or less than 0.5 wt % of the dough.

Preferably, the anti-blooming agent is selected from one or more of sorbitan monostearate (SMS), sorbitan tristearate, ethoxylated sorbitan esters of fatty acids, and lactylated mono diglycerides.

In accordance with the present invention, the dough composition may further comprise an emulsifier, wherein the emulsifier may be in the form of a liquid emulsifier or a powdered emulsifier, and are considered to also fall within the terms wet component and dry component, respectively. Where added, the emulsifier is present in an amount of up to 5 wt %, for example up to 1 wt %, such as up to 0.5 wt % of the dough composition.

Suitable emulsifiers include lecithin, lysolecithin, enzyme-decomposed lecithin, mono-and diglycerides of fatty acids, diacetyl tartaric acid ester of mono- and diglycerides, sodium stearoyl lactylate, calcium stearoyl lactylate, saccharose fatty acid esters, polyglycerol condensed ricinoleic acid ester, polyglycerol fatty acid esters and sorbitan fatty acid esters.

In a preferred embodiment, the dough composition is substantially free of an emulsifier.

It will be appreciated that the types and amounts of wet and dry components incorporated into the dough composition will dependent on the edible food product to be formed. It is considered that a person of skill in the art in this field would be able to select the necessary components, and their relative amounts, according to the desired final product.

The doughs of the present invention may be used to form edible food products such as biscuits, cookies, crackers, hardtack, pretzels, cut bread, wafers, sable, Langue du chat, macaroons, butter cakes (such as pound cake, fruit cake, Madeleine, Baumkuchen, castella), sponge cakes (such as short cake, roll cake, torte, decorated cake, chiffon cake), cream puffed confectionery, fermentation pastry, western style fresh confectionery such as pie and waffle, sweet buns, French bread, stollen, panettone, brioche, donuts, Danish pastry and croissants. Preferably, the edible food product is a cookie or a biscuit.

In another aspect of the present invention, there is provided, a process for forming an edible product having substantially no bloom formation on the surface or wherein the bloom formation on the surface of the edible product is reduced, retarded or delayed, comprising the steps of:
a. forming a dough as defined above; and
b. cooking the dough.

With regards to the step of forming the dough, it will be understood that the wet and dry components of the dough can be combined using any known techniques in the art. Suitable mixing devices are well known in the art and include those, for example, sold by Hobart, Fimar, GAM, Sirman, and Sammic.

The length of time required to form the dough is dependent on, amongst other things, the number of dry and wet components to be combined, the weight and/or volume of each of the components as well as the viscosity of the composition formed. In general, suitable mixing times can include from 10 seconds to 1 hour, such as from 1 to 45 minutes, and including from 5 to 30 minutes.

The dough may be cooked by baking, microwaving, or frying, such as shallow frying and/or deep-fat frying.

It will also be appreciated that the food product may also be par-cooked, such that a fully cooked food product can be prepared at a later time. Once par-cooked, the food product may be stored, packaged and/or frozen.

In a preferred embodiment the process of forming an edible embodiment may further comprise forming an edible surface coating onto the cooked dough. The edible coating layer may be of a thickness of up to 3 mm, for example up to 2 mm, such as 1 mm. Where the edible baked product comprises an edible surface coating, the fat compositions of the present invention prevent, reduce, retard and/or delay bloom formation on the surface of the edible surface coating.

Preferably, the edible surface coating may be selected from an edible fat based product such as chocolate. As used herein the term “chocolate” will be understood to mean chocolate and/or chocolate-like products. Some chocolate comprises cocoa butter, typically in substantial amounts, whereas some chocolate-like product may be produced comprising low amounts of cocoa butter or even without cocoa butter, e.g. by replacing the cocoa butter with cocoa butter equivalent, cocoa butter substitute or cocoa butter replacers. Cocoa butter and cocoa butter equivalents are typically rich in symmetrical SUS triglycerides. In a preferred embodiment, the edible coating layer is selected from a chocolate coating comprising cocoa butter or cocoa butter equivalents.

Although many chocolate products comprise cocoa powder or cocoa mass, some chocolate products, such as typical white chocolates, may be produced without cocoa powder. Where the chocolate product is produced without cocoa powder, the chocolate flavour may be provided, for example, by use of cocoa butter.

As will be appreciated by persons of skill in the art, the legal definition of chocolate may vary according to country and/or region, where there may be differing restrictions on which products may be marketed as chocolate. For the purposes of the present application, the term “chocolate” is considered to encompass any product, which at least is experienced by the consumer as chocolate or as a confectionery product having sensorial attributes common with chocolate, such as e.g. melting profile, taste etc, as well as any product falling within the chocolate definition provided herein.

Such a coating may be applied using known techniques such as coating, sandwiching, spreading, spraying, dipping, brushing, filling, embedding, and topping.

In a further aspect of the present invention, there is provided a vegetable fat suitable for use in forming an edible product having substantially no bloom formation on the surface or wherein the bloom formation on the surface of the baked edible product is reduced, retarded or delayed, wherein the vegetable fat composition comprises:
i. a (PSU+SPU+PPU+SSU+SUU+USU)/(PUP) ratio of greater than 1.0;
ii. PPP+PPS+PSP+SSP+SPS+SSS in an amount of less than 15 wt. %;
iii. SSU+PPU+PSU+SPU in an amount of greater than 6 wt. %;
iv. UUU is an amount of greater than 6 wt. %;
v. C₁₂+C₁₄ saturated fatty acids in an amount of less than 1.4 wt. %
   in which U is the sum of C18:1, C18:2 and C18:3 unsaturated fatty acids, S is stearic acid (C18:0), P is palmitic acid (C16:0); and wherein the fat composition has:
1. a solid fat content at 10° C. greater than 10%;
2. a solid fat content at 20° C. less than 50%; and
3. a solid fat content at 20° C.—solid fat content at 35° C. less than 30%.

The vegetable fat composition may be in the form of a solid or liquid at room temperature, or a mixture thereof. In some embodiments, the vegetable fat composition may be formed from a mixture or blend of two or more vegetable fats. Preferably, the vegetable fat composition may be selected from one or more of sunflower oil, high oleic sunflower oil, soybean oil, rapeseed oil, corn oil, safflower oil, sesame oil, rice oil, olive oil, peanut oil, flaxseed oil, cottonseed oil, shea butter, cocoa butter, illipe, sal, and palm oil, palm kernel oil, coconut oil, all with fractions thereof, such as olein and/or stearin fractions, as well as interesterified and/or hydrogenated fats or oils thereof.

Preferably, the vegetable fat composition is selected from a non-hydrogenated fat.

More preferably, the vegetable fat composition may be selected from one or more of the non-hydrogenated forms of palm oil, sheabutter, rapeseed oil, sunflower oil, and high oleic sunflower oil.

In some embodiments, the vegetable fat composition is selected from a non-hydrogenated fat comprising more than 15 wt % palm oil or its fractions; more than 15 wt % shea or its fractions; and/or more than 25 wt % interesterified components.

Preferably, the vegetable fat composition comprises:
more than 15 wt % palm oil or its fractions;
more than 15 wt % shea or its fractions; and
more than 25 wt % interesterified components.

In a preferred embodiment, the vegetable fat composition comprises a (PSU+SPU+PPU+SSU+SUU+USU)/(PUP) ratio of greater than 1.5, for example greater than 5.0, such as greater than 10.0.

Preferably, the vegetable fat composition comprises a (PSU+SPU+PPU+SSU+SUU+USU)/(PUP) ratio of less than 50, for example less than 25, such as less than 15.

In a preferred embodiment, the vegetable fat composition comprises PPP+PPS+PSP+SSP+SPS+SSS in an amount of less than 10 wt. %, for example less than 7 wt %, such as less than 5 wt %.

Preferably, the vegetable fat composition comprises PPP+PPS+PSP+SSP+SPS+SSS in an amount greater than 0.2 wt %, for example greater than 1 wt %, such as 3 wt %.

In a preferred embodiment, the vegetable fat composition comprises PSU+SPU+SSU+PPU in an amount of greater 9 wt %, for example greater than 12 wt %, such as 15 wt %.

Preferably, the vegetable fat composition comprises PSU+SPU+SSU+PPU in an amount less than 30 wt %, for example less than 25 wt %, such as 17 wt %.

In a preferred embodiment, the vegetable fat composition comprises UUU in an amount of greater than 10 wt %, for example greater than 15 wt %, such as greater than 20 wt %.

In a preferred embodiment, the vegetable fat composition comprises UUU in an amount of less than 50 wt %, for example less than 40 wt %, such as less than 30 wt %.

In a preferred embodiment, the vegetable fat composition comprises SUS+PUP in an amount of less than 15 wt %, for example, less than 12 wt %, such as less than 10 wt %.

In a preferred embodiment, the vegetable fat composition comprises SUS+PUP in an amount greater than 5 wt %, for example greater than 6 wt %, such as greater than 8 wt %.

In a preferred embodiment, the vegetable fat composition comprises SAFAs in an amount greater than 20 wt %, for example greater than 25 wt %, such as greater than 35 wt %.

In a preferred embodiment, the vegetable fat composition comprises SAFAs in an amount of less than 55 wt %, for example less than 50 wt %, such as less than 40 wt %.

In a preferred embodiment, the vegetable fat composition comprises a C_{18:0}/C_{16:0} ratio greater than 0.3, for example greater than 0.5, such greater than as 0.7.

In a preferred embodiment, the vegetable fat composition comprises a C_{18:0}/C_{16:0} ratio of less than 4, for example less than 3, such as less than 2.5.

In a preferred embodiment, the vegetable fat composition comprises PSU+SPU in an amount greater than 5 wt %, for example greater than 6 wt %, such as greater than 8 wt %.

In a preferred embodiment, the vegetable fat composition comprises PSU+SPU in an amount of less than 15 wt %, such as less than 12 wt %, for example less than 10 wt %.

In a preferred embodiment , the vegetable fat composition has a solid fat content at 10° C. of greater than 20%, for example greater than 25%, such as greater than 30%.

In a preferred embodiment, the vegetable fat composition has a solid fat content at 10° C. of less than 50%, for example less than 45%, for example less than 40%.

In a preferred embodiment, the vegetable fat composition has a solid fat content at 20° C. of greater than 10%, for example greater than 15%, such as greater than 20%.

In a preferred embodiment, the vegetable fat composition has a solid fat content at 20° C. of less than 35%, for example less than 30%, such as less than 25%.

In a preferred embodiment, the vegetable fat composition has a solid fat content at 35° C. of between 0% and 10%, for example between 2% and 8%, such as between 4% and 6%.

In a preferred embodiment, the vegetable fat composition comprises C₁₂+C₁₄ saturated fatty acids in an amount of at least 0.01 wt %, for example at least 0.3 wt %, such as 0.5 wt %.

In a preferred embodiment, the vegetable fat composition comprises C₁₂+C₁₄ saturated fatty acids in an amount of less than 1.2 wt %, for example less than 1.0 wt %, such as 0.5 wt %.

In a preferred embodiment, the vegetable fat composition comprises trans unsaturated fatty acids in an amount of less than 5 wt %, for example less than 2 wt %, such as less than 1 wt %.

It will be readily appreciated that this vegetable fat composition may be used to form a dough suitable for producing an edible food product having substantially no bloom formation on the surface or wherein the bloom formation is reduced, retarded or delayed, such as described above, and in accordance with the methods described above.

The inventors have surprisingly found that the use of such a vegetable fat as defined herein, in a dough for forming an edible food product, provides for an extended resistance to fat blooming by preventing, reducing, retarding or delaying fat bloom formation. For example, edible food products formed are stable and do not display the presence of fat blooming for at least 10 weeks, for example at least 18 weeks, such as at least 50 weeks.

Such a use is in accordance with yet another aspect of the present invention, and encompasses the use of such fats in doughs, methods of making such doughs, edible food products formed from such doughs, methods of making such food products and all fats as described herein.

In still another aspect of the present invention, there is provided an edible food product, such as a baked food product, having substantially no bloom formation on the surface or wherein the bloom formation on the surface of the baked product is reduced, retarded or delayed, wherein the edible food product is formed from a dough comprising:
a. 5 to 40 wt % of a vegetable fat composition for preventing, reducing, retarding or delaying bloom formation on the surface of the baked product;
b. 5 to 50 wt % of sugar; and
c. 5 to 75 wt % of flour
   wherein the vegetable fat composition comprises:
i. a (PSU+SPU+PPU+SSU+SUU+USU)/(PUP) ratio of greater than 1.0;
ii. PPP+PPS+PSP+SSP+SPS+SSS in an amount of less than 15 wt. %;
iii. SSU+PPU+PSU+SPU in an amount of greater than 6 wt. %; and
iv. UUU is an amount of greater than 6 wt. %;
   in which U is the sum of C18:1, C18:2 and C18:3 unsaturated fatty acids, S is stearic acid (C18:0), P is palmitic acid (C16:0); and wherein the fat composition has:
1. a solid fat content at 10° C. greater than 10%;
2. a solid fat content at 20° C. less than 50%; and
3. a solid fat content at 20° C.—solid fat content at 35° C. less than 30%;
   and wherein the edible product comprises a surface coating selected from a chocolate surface coating, the chocolate surface coating not comprising a fat having an SOS content of between 40 to 90 mass % and an SU2 and U3 content of between 10 and 40 mass %.

In accordance with the present invention, the term “SOS” refers to a triglyceride arranged such that an oleic acid is positioned between two stearic acids compounds; and U refers to an unsaturated fatty acid having a carbon number of not less than 16.

It will be readily appreciated that preferred features of the dough composition may be a described herein, and that the dough may be used to form an edible food product having substantially no bloom formation on the surface or reduced, retarded or delayed bloom formation such as described above, and in accordance with the methods described above.

Preferably, C₁₂+C₁₄ saturated fatty acids are present in an amount of less than 2.5 wt. %.

Also provided by the present invention is a method of preparing a dough for forming an edible product having substantially no bloom formation on the surface or wherein the bloom formation on the surface of the product is reduced, retarded or delayed, the method comprising the steps of blending:
a. 5 to 40 wt % of a vegetable fat composition for preventing, reducing, retarding or delaying bloom formation on the surface of the baked product;
b. 5 to 50 wt % of sugar; and
c. 5 to 75 wt % of flour
   wherein the vegetable fat composition comprises:
i. a (PSU+SPU+PPU+SSU+SUU+USU)/(PUP) ratio of greater than 1.0;
ii. PPP+PPS+PSP+SSP+SPS+SSS in an amount of less than 15 wt. %;
iii. SSU+PPU+PSU+SPU in an amount of greater than 6 wt. %; and
iv. UUU is an amount of greater than 6 wt. %
v. saturated fatty acids C₁₂+C₁₄ in an amount of less than 2.5 wt. %
   in which U is the sum of C18:1, C18:2 and C18:3 unsaturated fatty acids, S is stearic acid (C18:0), P is palmitic acid (C16:0); and wherein the fat composition has:
1. a solid fat content at 10° C. greater than 10%;
2. a solid fat content at 20° C. less than 50% ; and
3. a solid fat content at 20° C.—solid fat content at 35° C. less than 30%.

By way of example, the method of preparing a dough for forming an edible product having substantially no bloom formation on the surface or wherein the bloom formation on the surface of the product is reduced, retarded or delayed, may comprise the steps of:
a. mixing the wet components;
b. mixing the dry components; and
c. blending a. and b. to form a dough.

Preferably, the wet components and dry components may be selected from one or more of the wet components and/or dry components as defined above.

Having regard to the above disclosure, the present invention also comprises the use of a dough as disclosed herein for the formation of an edible product having substantially no bloom formation on the surface or wherein the bloom formation on the surface of the product is reduced, retarded or delayed. Furthermore, the present invention also comprises the use of a vegetable fat composition as disclosed herein for the formation of an edible product having substantially no bloom formation on the surface or wherein the bloom formation on the surface of the product is reduced, retarded or delayed.

The fatty acid composition of an oil or fat can be determined by a gas chromatographic analysis of the methyl ester derivatives, prepared by transesterification. The technique of gas-liquid chromatography (GLC), also referred to as gas chromatography (GC), is a form of partition chromatography in which the mobile phase is a gas and the stationary phase is a liquid. The sample is volatilised during injection and an equilibrium is formed between the gas phase and the liquid phase, which is fixed at the inner wall of the column. When the sample contains different components, they diffuse into the liquid phase to varying degrees according to their individual equilibrium constant, and so travel down the column at different rates. This results in different retention times, and thus a physical separation. The separated components emerge from the end of the column exhibiting peaks of concentration, ideally with a Gaussian distribution. These peaks are detected by the Flame Ionization Detector (FID), which converts the concentration of the component in the gas phase into an electrical signal, which is amplified and passed to a continuous recorder, so that the progress of the separation can be monitored and quantified.

The triacylglycerol composition in oils and fats can be determined by using a Gas Chromatography (GC) with a cold-on-column (COC) injector and a Flame Ionization Detector (FID). Before the sample can be analysed, it must be derivatised to protect the free OH-groups of the mono-and diglycerides in order prevent a wide peak broadening.

Alternatively, triacylglycerols in vegetable oils can be analysed using High Performance Liquid Chromatography (HPLC) in combination with a Refractive Index (RI) detector (based on AOCS Ce 5b-89).

The stereospecificity of triacylglycerols can be analysed by High Performance Liquid Chromatography (HPLC) in combination with an Evaporative Light Scattering Detector (ELSD). The sample preparation consists of an epoxidation of the double bonds of unsaturated fatty acids.

Alternatively, the stereospecificity of triacylglycerols can be analysed by means of High Performance Liquid Chromatography (HPLC) on Silver Ion columns and detected by ELSD.

The present inventions will now be described by way of example.

### EXAMPLES IN ACCORDANCE WITH THE PRESENT INVENTION

### Example 1

Cookies were made based on the recipe in Table 1. The cookie dough was laminated until a final thickness of 5 mm, circles with diameter 50 mm were cut and baked for 20 minutes at 180° C. in a deck oven.

The following fat blends were used:

Fat 1=65 wt % of a chemical interesterification of (42 wt % shea olein and 58 wt % palm stearin IV35) and 35% wt % shea olein

Fat 1=blend of 38 wt % palm olein (with IV 64) with 62 wt % chemically interesterified palm oil

TABLE 1

| | |
|---|---|
| Flour | 100 |
| Fat | 53.3 |
| Icing sugar | 42.9 |
| Water | 13.3 |
| Eggs | 4.8 |
| Salt | 0.7 |
| Baking powder | 0.6 |

The cookies were tempered at 25° C. and fully enrobed with tempered dark chocolate. The chocolate layer has a thickness of 1.5 mm and is, on average, 33.5 wt % of the total cookie weight. The chocolate composition is 40 wt % cocoa mass, 10 wt % cocoabutter, 49.58 wt % sugar, 0.4 wt % lecithin, and 0.02 wt % vanilin.

The chemical characteristics and bloom result are shown in Table 2.

TABLE 2

| | Fat 1 | Fat 2 |
|---|---|---|
| UUU | 10.4 | 10.4 |
| UUP | 12.2 | 29.5 |
| UPU | 5.4 | 8.4 |
| PPU | 8.5 | 12.4 |
| PUP | 4.4 | 13.6 |
| UUS | 22.2 | 2.9 |
| USU | 4.0 | 0.9 |
| SSU | 1.4 | 0.1 |
| SUS | 2.2 | 0.2 |
| PPP | 3.5 | 4.9 |
| PPS | 2.6 | 1.0 |
| PSP | 1.3 | 0.5 |
| SSP | 1.0 | 0.1 |
| SPS | 0.5 | 0.1 |
| SSS | 0.2 | 0.0 |
| UPS + USP | 6.5 | 2.6 |
| PUS | 4.2 | 2.8 |
| SUS + PUP | 6.7 | 13.8 |
| SSU + PPU | 9.8 | 12.5 |
| SSU + PPU + PSU + SPU | 16.3 | 15.1 |
| (PSU + SPU + PPU + SSU + SUU + USU)/ | 9.55 | 1.39 |
| (PUP) | | |
| PPP + PPS + PSP + SSP + SPS + SSS | 9.0 | 6.57 |
| SAFA | 48.3 | 46.1 |
| C12 + C14 | 0.6 | 1.7 |
| N10 | 30.0 | 55.0 |
| N20 | 20.0 | 27.0 |
| N20-N35 | 13.2 | 24.5 |
| C18:0/C16:0 | 0.75 | 0.11 |
| Dough | 1 | 2 |
| weeks bloom stable at 20° C. | >50 | 18 |

### Comparative Examples

Fat 3=chemical interesterification of 70 wt % palm oil and 30 wt % palm kernel oil

Fat 4=chemical interesterification of 70 wt % shea butter and 30 wt % coconut oil

Fat 5=100% palm oil

Fat 6=100% shea butter

Fat 7=blend of 30% palm mid fraction (IV33) and 70% rapeseed oil

| | Fat 3 | Fat 4 | Fat 5 | Fat 6 | Fat 7 |
|---|---|---|---|---|---|
| UUU | 6.2 | 5.5 | 4.8 | 6.6 | 52.7 |
| UUP | 10.1 | 2.0 | 30.7 | 2.7 | 10.5 |
| UPU | 5.1 | 1.0 | 3.4 | 0.3 | 1.2 |
| PPU | 8.3 | 0.4 | 2.4 | 0.1 | 2.2 |
| PUP | 4.2 | 0.2 | 32.3 | 0.6 | 20.1 |
| UUS | 1.2 | 8.3 | 2.8 | 27.1 | 5.0 |
| USU | 0.6 | 4.2 | 0.3 | 3.0 | 0.6 |
| SSU | 0.1 | 6.3 | 0.1 | 3.9 | 0.0 |
| SUS | 0.1 | 3.2 | 0.5 | 35.2 | 0.4 |
| PPP | 3.4 | 0.0 | 5.8 | 0.1 | 0.6 |
| PPS | 0.8 | 0.3 | 0.7 | 0.0 | 0.1 |
| PSP | 0.4 | 0.1 | 0.7 | 0.0 | 0.1 |
| SSP | 0.1 | 1.2 | 0.1 | 0.1 | 0.0 |
| SPS | 0.0 | 0.6 | 0.1 | 0.1 | 0.0 |
| SSS | 0.0 | 2.4 | 0.0 | 0.8 | 0.0 |
| UPS + USP | 1.9 | 3.1 | 0.7 | 0.6 | 0.5 |
| PUS | 0.9 | 1.5 | 5.8 | 5.2 | 3.7 |
| SUS + PUP | 4.2 | 3.4 | 32.7 | 35.8 | 20.5 |
| SSU + PPU | 8.5 | 6.7 | 2.5 | 4.0 | 2.3 |
| SSU + PPU + PSU + SPU | 10.4 | 9.8 | 3.2 | 4.6 | 2.7 |
| (PSU + SPU + PPU + | 2.9 | 120 | 0.20 | 58.57 | 0.41 |
| SSU + SUU + USU)/(PUP) | | | | | |
| PPP + PPS + PSP + SSP + | 4.7 | 4.6 | 7.28 | 1.13 | 0.79 |
| SPS + SSS | | | | | |
| SAFA | 59.9 | 60.8 | 50.9 | 48.2 | 24.8 |
| C12 + C14 | 20.1 | 19.2 | 2.0 | 0.0 | 0.4 |
| N10 | 59 | 50 | 48 | 55.0 | 20.7 |
| N20 | 32 | 28 | 24 | 33.9 | 4.7 |
| N20-N35 | 28 | 23.5 | 18 | 33.9 | 4.4 |
| C18:0/C16:0 | 0.12 | 6.15 | 0.10 | 12.7 | 0.14 |
| Dough | 3 | 4 | 5 | 6 | 7 |
| weeks bloom stable at | >50 | >50 | 5 | 7 | 3 |
| 20° C. | | | | | |

Comparative fats 3 and 4 are bloom stable, but are high in C₁₂ and C₁₄ and generally high in saturated fatty acids.

From a nutritional point of view it is highly preferred to limit the amount of saturated fatty acids. It has been demonstrated that consumption of saturated fatty acids increases the risk to the occurrence of cardiovascular diseases. There is also growing evidence that different types of saturated fatty acids might have different cholesterogenic effects. Typically, myristic acid (C14:0) has a strong hypercholesterolemic effect according to Müller et al. (Lipids, 2001, Vol. 36, 8, 783-791). Myristic acid can be found in high amounts in lauric fats (coconut oil, palm kernel oil). Accordingly, more generally, it will be appreciated that an advantage of the fats of the present invention is not only the ability to address issues regarding the physical appearance of the resulting edible product (i.e. bloom formation) but also the nutritional value of such products.

Comparative fats 5, 6 and 7 showed bloom spots already after a few weeks at 20° C.

### Example 2

Uncoated cookies containing cocoa powder in the dough were produced with Fat 1, 2 and 5 and maintained at a temperature of 20° C., with the following results:

| Weeks at 20° C. | Fat 1 | Fat 2 | Comparative fat 5 |
|---|---|---|---|
| 1 | No bloom | No bloom | No bloom |
| 15 | No bloom | No bloom | Some signs of |
| | | | bloom |
| 30 | No bloom | No bloom | Heavily bloomed, |
| | | | big white spots |
| | | | visible |

### Example 3

Cookies were made according to the recipe and procedure of Example 1. The cookies did not contain cocoa powder and were not enrobed with chocolate.

The colour of the cookies were followed up in time using a Byk colorimeter using the CIE L*a*b*-system. The person of skill in the art would be aware that the standardised values produced by the Byk colorimeter are in reference to a 3D plot, wherein the 3D plot comprises an axis corresponding to the luminance (L*), which varies from 0 (black) to 100 (white), and two axes relating to colour, in particular, a* relates the spectrum of red-green, and b* relates to the spectrum of blue-yellow. Values are typically expressed in terms of a measured difference compared to a standard sample, instead of absolute values.

ΔE* defines the total colour difference between two measurements, for example the same sample measured after a specified time period or the measurement of two different samples. The colour difference of the cookies were calculated as shown below.

ΔE*=\sqrt{(ΔL*²)+(Δa*)²+(Δb*)²} with measurement on day 0 and measurement after 11 weeks.

| | ΔE* |
|---|---|
| Fat 1 | 15.3 |
| Fat 2 | 19.1 |
| Comparative Fat 6 | 30.0 |

It is immediately evident that there is a significant difference in the colour difference measured for the cookies comprising Fats 1 and 2 and the cookie comprising comparative Fat 6. Comparative Fat 6 resulted in white coloured cookies.

### Example 4

Digestive biscuits were made using the following dough fats:
Fat 1 of Example 1; and
Fat 5 of Example 1

The biscuits were coated with two different dark chocolates (as shown in the table below).

The vegetable fat is a blend of 52.5% palm mid fraction (IV40), 25% shea stearin and 22.5% palmolein (IV56) by weight.

The vegetable fat is typically softer than cocoabutter and has a (PU2+SU2+UUU) content of 15.5 wt %.

| | Dark chocolate 1 | Dark chocolate 2 |
|---|---|---|
| Sugar | 49.58 | 49.58 |
| Cocoa mass | 40 | 40 |
| Cocoabutter | 10 | 5 |
| Vegetable fat | 0 | 5 |
| Lecithin | 0.4 | 0.4 |
| Vanillin | 0.02 | 0.02 |
| PU2 + SU2 + UUU | 6.6 | 8.0 |
| (wt %) | | |

The chocolate coated biscuits produced were inspected for bloom at 20° C. and 23° C., with the results being as noted below:

| | | First signs of | Significant | First signs of | Significant |
|---|---|---|---|---|---|
| | | bloom after | bloom after | bloom after | bloom after |
| | Dark | . . . weeks at | . . . weeks at | . . . weeks at | . . . weeks at |
| Fat | chocolate | 20° C. | 20° C. | 23° C. | 23° C. |
| Fat 1 | 1 | None after | None after | 8 | 22 |
| | | 30 weeks | 30 weeks | | |
| Fat 1 | 2 | None after | None after | 16 | None after |
| | | 30 weeks | 30 weeks | | 30 weeks |
| Fat 5 | 1 | 8 | 9 | 4 | 4 |
| Fat 5 | 2 | 15 | 27 | 5 | 7 |

It can be clearly seen that a dough according to the present claims displays improved bloom stability in combination with a chocolate coating, and particular improvement in combination with a chocolate coating having increased PU2+SU2+UUU content.

1-51. (canceled)

52. A dough comprising:
a. 5 to 40 wt % of a vegetable fat composition for preventing, reducing, retarding, or delaying bloom formation on the surface of the edible product;
b. 5 to 50 wt % of sugar; and
c. 5 to 75 wt % of flour;
wherein the vegetable fat composition comprises:
i. a (PSU+SPU+PPU+SSU+SUU+USU)/(PUP) ratio of greater than 1.0;
ii. PPP+PPS+PSP+SSP+SPS+SSS in an amount less than 15 wt %;
iii. SSU+PPU+PSU+SPU in an amount greater than 6 wt %;
iv. UUU in an amount greater than 6 wt %; and
v. C₁₂+C₁₄ saturated fatty acids in an amount less than 2.5 wt %¹
wherein U is the sum of C18:1, C18:2, and C18:3 unsaturated fatty acids, S is stearic acid (C18:0), and P is palmitic acid (C16:0); and wherein the fat composition has:
1. a solid fat content at 10° C. greater than 10%;
2. a solid fat content at 20° C. less than 50%; and
3. a solid fat content at 20° C.-35° C. less than 30%.

53 The dough of claim 52, wherein the vegetable fat comprises a (PSU+SPU+PPU+SSU+SUU+USU)/(PUP) ratio of greater than 1.5.

54. The dough of claim 52, wherein the vegetable fat composition comprises a (PSU+SPU+PPU+SSU+SUU+USU)/(PUP) ratio of less than 50.

55. The dough of claim 52, wherein the vegetable fat composition comprises PPP+PPS+PSP+SSP+SPS+SSS in an amount less than 10 wt %.

56. The dough of claim 52, wherein the vegetable fat composition comprises PPP+PPS+PSP+SSP+SPS+SSS in an amount greater than 0.2 wt %.

57. The dough of claim 52, wherein the vegetable fat composition comprises PSU+SPU+SSU+PPU in an amount greater than 9 wt %.

58. The dough of claim 52, wherein the vegetable fat composition comprises PSU+SPU+SSU+PPU in an amount less than 30 wt %.

59. The dough of claim 52, where the vegetable fat composition comprises UUU in an amount greater than 10 wt %.

60. The dough of claim 52, wherein the vegetable fat composition comprises UUU in an amount less than 50 wt %.

61. The dough of claim 52, wherein the vegetable fat composition comprises SUS+PUP in an amount less than 15 wt %.

62. The dough of claim 52, wherein the vegetable fat composition comprises SUS+PUP in an amount greater than 5 wt %.

63. The dough of claim 52, wherein the vegetable fat composition comprises SAFAs in an amount greater than 20 wt %.

64. The dough of claim 52, wherein the vegetable fat composition comprises SAFAs in an amount less than 55 wt %.

65. The dough of claim 52, wherein the vegetable fat composition comprises a C_{18:0}/C_{16:0} ratio greater than 0.3.

66. The dough of claim 52, wherein the vegetable fat composition comprises a C_{18:0}/C_{16:0} ratio less than 4.

67. The dough of claim 52, wherein the vegetable fat composition comprises PSU+SPU in an amount greater than 5 wt %.

68. The dough of claim 52, wherein the vegetable fat composition comprises PSU+SPU in an amount less than 15 wt %.

69. The dough of claim 52, wherein the vegetable fat composition has a solid fat content at 10° C. of greater than 20%.

70. The dough of claim 52, wherein the vegetable fat composition has a solid fat content at 20° C. of less than 35%.

71. The dough of claim 52, wherein the vegetable fat composition has a solid fat content at 35° C. of between 0 and 10%.

72. The dough of claim 52, wherein the vegetable fat composition is selected from one or more of sunflower oil, high oleic sunflower oil, soybean oil, rapeseed oil, cottonseed oil, shea butter, cocoa butter, illipe, sal and palm oil, and interesterified and/or hydrogenated fats or oils thereof.

73. The dough of claim 72, wherein the vegetable fat composition is selected from one or more of the non-hydrogenated forms of palm oil, shea butter, rapeseed oil, sunflower oil, and high oleic sunflower oil.

74. The dough of claim 72, wherein the vegetable fat composition comprises a non-hydrogenated fat comprising more than 15 wt % palm oil or its fractions; more than 15 wt % shea or its fractions; and more than 25 wt % interesterified components.

75. The dough of claim 52, wherein the vegetable fat composition is a blend of two or more vegetable fats.

76. The dough of claim 52, wherein the vegetable fat composition comprises C₁₂+C₁₄ saturated fatty acids in an amount of at least 0.01 wt. %.

77. The dough of claim 52, wherein the vegetable fat composition comprises C₁₂+C₁₄ saturated fatty acids in an amount less than 1.4 wt. %.

78. The dough of claim 52, wherein the dough further comprises one or more of eggs, water, liquid emulsifier, liquid sugar and syrups, milk, liquid flavors, alcohols, humectants, honey, liquid preservatives, liquid sweeteners, liquid oxidizing agents, liquid reducing agents, liquid anti-oxidants, liquid acidity regulators, liquid enzymes, milk powder, yeast, sugar substitutes, protein, powdered emulsifiers, starch, salt, spices, flavor components, colorants, cocoa, thickening and gelling agents, egg powder, enzymes, gluten, preservatives, sweeteners, oxidizing agents, reducing agents, anti-oxidants, and acidity regulators.

79. The dough of claim 52, wherein the vegetable fat composition has a content of trans unsaturated fatty acids lower than 5 wt %.

80. The dough of claim 52, wherein the vegetable fat composition is not hydrogenated.

81. A vegetable fat composition comprising:
i. a (PSU+SPU+PPU+SSU+SUU+USU)/(PUP) ratio of greater than 1.0;
ii. PPP+PPS+PSP+SSP+SPS+SSS in an amount less than 15 wt. %;
iii. SSU+PPU+PSU+SPU in an amount greater than 6 wt. %;
iv. UUU in an amount greater than 6 wt. %;
v. C₁₂+C₁₄ saturated fatty acids in an amount less than 1.4 wt. %;
wherein U is the sum of C18:1, C18:2, and C18:3 unsaturated fatty acids, S is stearic acid (C18:0), and P is palmitic acid (C16:0); and wherein the fat composition has:
1. a solid fat content at 10° C. greater than 10%;
2. a solid fat content at 20° C. less than 50%; and
3. a solid fat content at 20° C.-35° C. less than 30%.

82. An edible food product formed from the dough of claim 52.

83. An edible food product comprising the vegetable fat composition of claim 81.

84. The edible food product of claim 82, wherein the edible food product further comprises a surface coating consisting of one or more edible fats.

85. The edible food product of claim 84, wherein the surface coating is a chocolate surface coating.

86. An edible food product comprising:
a. 5 to 40 wt % of a vegetable fat composition for preventing, reducing, retarding, or delaying bloom formation on the surface of the edible food product;
b. 5 to 50 wt % of sugar; and
c. 5 to 75 wt % of flour;
wherein the vegetable fat composition comprises:
i. a (PSU+SPU+PPU+SSU+SUU+USU)/(PUP) ratio of greater than 1.0;
ii. PPP+PPS+PSP+SSP+SPS+SSS in an amount less than 15 wt. %;
iii. SSU+PPU+PSU+SPU in an amount greater than 6 wt. %; and
iv. UUU in an amount greater than 6 wt. %;
wherein U is the sum of C18:1, C18:2, and C18:3 unsaturated fatty acids, S is stearic acid (C18:0), and P is palmitic acid (C16:0); and wherein the fat composition has:
1. a solid fat content at 10° C. greater than 10%;
2. a solid fat content at 20° C. less than 50%; and
3. a solid fat content at 20° C.-35° C. less than 30%;
and wherein the edible product comprises a chocolate surface coating, wherein the chocolate surface coating does not comprise a fat having an SOS content of between 40 to 90 mass % and an SU2 and U3 content of between 10 and 40 mass %.

87. The edible food product of claim 86, wherein the chocolate surface coating has a thickness of up to 3 mm.

88. The edible food product of claim 86, wherein the product is a biscuit, cake, muffin, donut, pastry, or bread.

89. A method of preparing a dough for forming an edible product having substantially no bloom formation on the surface or wherein the bloom formation on the surface of the edible product is reduced, retarded, or delayed, the method comprising the steps of blending:
a. 5 to 40 wt % of a vegetable fat composition for preventing, reducing, retarding or delaying bloom formation on the surface of the edible product;
b. 5 to 50 wt % of sugar; and
c. 5 to 75 wt % of flour;
wherein the vegetable fat composition comprises:
i. a (PSU+SPU+PPU+SSU+SUU+USU)/(PUP) ratio of greater than 1.0;
ii. PPP+PPS+PSP+SSP+SPS+SSS in an amount less than 15 wt. %;
iii. SSU+PPU+PSU+SPU in an amount greater than 6 wt. %;
iv. UUU in an amount greater than 6 wt. %; and
v. saturated fatty acids C12+C14 in an amount less than 2.5 wt. %;
wherein U is the sum of C18:1, C18:2, and C18:3 unsaturated fatty acids, S is stearic acid (C18:0), and P is palmitic acid (C16:0); and wherein the fat composition has:
1. solid fat content at 10° C. greater than 10%;
2. a solid fat content at 20° C. less than 50%; and
3. a solid fat content at 20° C.-35° C. less than 30%.

90. The method of claim 89, further comprising:
(a) mixing wet components;
(b) mixing dry components; and
(c) blending (a) and (b) to form the dough.

91. The method of claim 90, wherein the wet components may further comprise one or more of eggs, water, liquid emulsifier, liquid sugar and syrups, milk, liquid flavors, alcohols, humectants, honey, liquid preservatives, liquid sweeteners, liquid oxidizing agents, liquid reducing agents, liquid anti-oxidants, liquid acidity regulators, and liquid enzymes.

92. The method of claim 90, wherein the dry components may further comprise one or more of milk powder, sugar substitutes, protein, powdered emulsifiers, yeast, starch, salt, spices, flavor components, colorants, cocoa, thickening and gelling agents, egg powder, enzymes, gluten, preservatives, sweeteners, oxidizing agents, reducing agents, antioxidants, and acidity regulators.

93. A process of forming an edible product having substantially no bloom formation on the surface or wherein the bloom formation on the surface of the edible product is reduced, retarded, or delayed, comprising the steps of:
a. forming the dough of claim 52; and
b. cooking the dough.

94. The process of claim 93, further comprising coating the cooked dough with a surface coating consisting of one or more edible fats.

95. A process for forming an edible product having substantially no bloom formation on the surface or wherein the bloom formation on the surface of the edible product is reduced, retarded, or delayed, comprising the steps of:
a. forming the dough of claim 86;
b. cooking the dough; and
c. coating the cooked dough with a chocolate surface coating.

96. The process of claim 93, wherein the cooking includes baking, frying, and/or microwaving.

97. The process of claim 93, wherein the cooking includes full and par-cooking.
